(19) United States
(12) Patent Application Publication
(10) Pub. No.: US 2012/0200531 A1
(43) Pub. Date: Aug. 9, 2012

(54) TOUCH PANEL DEVICE

(76) Inventor: Mikio Araki, Tokyo (JP)

(21) Appl. No.: 13/502,035

(22) PCT Filed: Feb. 17, 2010
(86) PCT No.: PCT/JP2010/000991

§ 371 Date: Apr. 13, 2012

(51) Int. Cl. G06F 3/044

(52) U.S. Cl. 345/174

(57) ABSTRACT

A touch panel device detects a touch position of a touch panel 4 by an electrostatic capacitance system with an opportunity that the interception of the infrared light irradiated on a touch surface is detected.

### TECHNICAL FIELD

The present invention relates to a touch panel device for detecting a touch position by an electrostatic capacitance system.

### BACKGROUND ART

For a conventional touch panel device, the one disclosed in Patent Document 1, for example, is specified. The device includes an infrared photosensor for detecting infrared light, and the infrared photosensor detects reflected infrared light such that infrared light for detection is reflected by an indication means such as a finger to be produced, and also the infrared light contained in outside light. The received light signals corresponding to the reflected infrared light and the infrared light contained in the outside light which are detected by the infrared photosensor are processed by a received light signal processing circuit section in the device, and the processed received light signals are transmitted to a position detection/light intensity detection circuit section. The position detection/light intensity detection circuit section detects that in an image-displaying area of a touch screen, the indication means is overlapped on the area where the infrared photosensor detecting the reflected infrared light is disposed. In such a way, the position of the indication means can be accurately determined.

Further, a display device disclosed in Patent Document 2 is arranged such that, when a contact body comes in contact with a face on the opposite side of an opposing substrate from a face where opposing electrodes are formed, an electrostatic capacitance created between the contact body and part of the opposing electrodes is sensed to thereby detect the contact position of the contact body. It is noted that a plurality of the opposing electrodes are formed in an elongated shape to be extended along signal lines formed on an active matrix substrate. In this way, since the opposing electrodes are formed in an elongated pattern having a long length and a narrow width along the signal lines, even when the sheet resistance of the opposing electrodes is relatively low, not a high resistance, the electrode can have a high resistance between both ends thereof in a direction along the signal lines. As a result, the detection accuracy of the contact position of the contact body to be detected can be remarkably increased in the direction of the signal lines. Further, since it is unnecessary to increase the sheet resistance of the opposing electrode, no degradation in display performance such as lowered contrast and occurrence of unevenness is caused.

Moreover, a flat display device disclosed in Patent Document 3 includes a display device board on which an electrode for providing an electric signal to a display device element which electro-optically responds is formed, and has an impedance surface formed on a face corresponding to a display area and a current detection circuit for detecting a current flowing on the impedance surface, wherein during the time the current detection circuit detects the current, from among the electrodes for providing the electric signal to the display device element, at least one of electrodes that transmit the electric signal from the exterior of the display area to the interior of the display area is kept in a high impedance. In this manner, when during the time the current detection circuit detects the current, from among the wirings or electrodes for providing the electric signal to the display device element, at least one of the wirings and electrodes arranged from the exterior of the display area to the interior thereof is kept in a high impedance, the signal-to-noise ratio of a position detection signal can be increased to reduce the cost of a signal processing circuit. Further, since the off state of a switching element in the display device board is held, deterioration in display characteristics thereof is eliminated.

However, in the device disclosed in Patent Document 1, since the resolution of a touch input is determined depending on the number of the infrared photosensors, in order to detect an accurate position of the indication means, a large number of infrared photosensors become necessary; thus, there is a problem such that the number of components thereof increases.

Furthermore, though the devices disclosed in Patent Document 2 and Patent Document 3 use the opposing substrate as an touch panel device of an electrostatic capacitance system, the effects due to the change in detection capacitance corresponding to the type of the indication means are not sufficiently considered. For this reason, when the pawl or finger of a hand wearing a glove providing a lower detection capacitance as compared with the finger of a bare hand is used as the indication means, it is necessary to increase the detection sensitivity; thus, there is a problem such that the device has a higher possibility to be malfunctioned when affected by ambient noise such as static electrical spark, water from the condensation on the touch surface, and so on.

The present invention is made to solve the above-mentioned problems, and an object of the invention is to provide a touch panel device that is not easily affected by ambient noise and so on to thereby restrain the occurrence of a malfunction thereof even when the detection sensitivity for an indication means is increased in the case that a touch position is detected by an electrostatic capacitance system.

### PRIOR ART DOCUMENTS

### Patent Documents

Patent Document 1: JP-A-2008-241807

Patent Document 2: JP-A-2007-304342

Patent Document 3: JP-A-2009-42899

### SUMMARY OF THE INVENTION

A touch panel device according to the present invention includes a touch panel of an electrostatic capacitance system; a detection section that receives the probe light irradiated on the touch surface of the touch panel to detect the presence or absence of the interception of the probe light from the intensity of the received light; and a control section that performs the detection of a touch position by the electrostatic capacitance system of the touch panel with an opportunity that the interception of the probe light is detected by the detection section.

According to the invention, the device is not easily affected by ambient noise and so on even when the detection sensitivity of the indication means is increased, and can restrain the occurrence of a malfunction thereof.

### BRIEF DESCRIPTION OF THE DRAWINGS

FIG. 1 is a graph showing the relationship between the depressed position and the detection capacitance on the touch surface in a touch panel device of an electrostatic capacitance system.

FIG. 2 is a view showing a configuration of a touch panel device in accordance with a first embodiment in the present invention.

FIG. 3 is a flowchart showing the flow of an operation of the touch panel device in accordance with the first embodiment.

FIG. 4 is a view showing a configuration of a touch panel device in accordance with a second embodiment in the invention.

FIG. 5 is a flowchart showing the flow of an operation of the touch panel device in accordance with the second embodiment.

### BEST MODE FOR CARRYING OUT THE INVENTION

In the following, embodiments for carrying out the present invention will now be described with reference to the accompanying drawings to explain the invention in more detail.

### First Embodiment

In a touch panel device of an electrostatic capacitance system, a touch position is determined by the detection capacitance in a depressed position on a touch surface by an indication means.

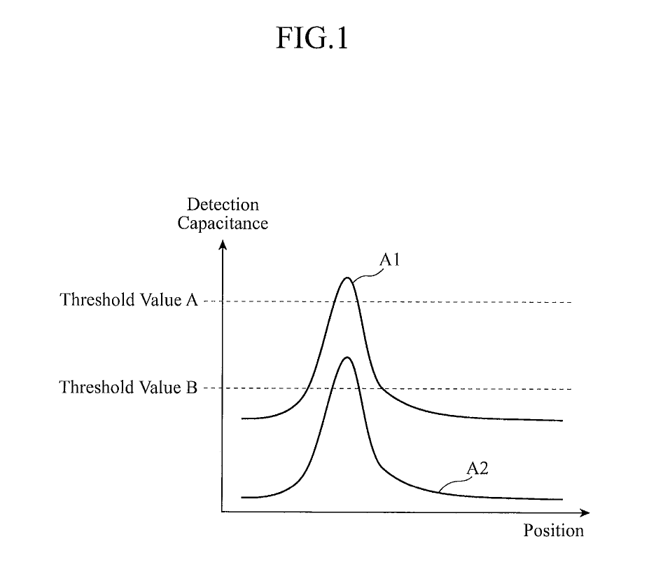

FIG. 1 is a graph showing the relationship between the depressed position and the detection capacitance on the touch surface in the touch panel device of the electrostatic capacitance system. As shown in FIG. 1, a touch input is detected according to whether the detection capacitance is beyond a predetermined threshold value or not. The detection capacitance has a property greatly affected by the type of the indication means, and a threshold value A is generally determined by estimating a capacitance characteristic A1 produced by the touch input of a bare finger.

On the other hand, in recent years, it is desired that a touch operation in an instance equipped with a glove providing a lesser change in capacitance or with a pawl can be detected. In this case, since a capacitance property A2 smaller in detection capacitance than the capacitance property A1 is appropriate, it is required that a threshold value B smaller than the threshold value A be established for the threshold value for determining the touch position.

However, since the establishment of the threshold value B leads to an increase of the sensitivity with respect to the change in capacitance, a possibility to be malfunctioned is increased under the influence of the change in capacitance due to ambient noise such as static electrical spark, the change in capacitance due to water drop produced by the condensation on the touch surface, or the like.

For this reason, in the touch panel device in accordance with the first embodiment, the detection of the touch position by an electrostatic capacitance system is started with an opportunity that the indication means screens the infrared light for detection irradiated in parallel to the touch surface. In doing so, even when the threshold value of the detection capacitance is lowered to increase the sensitivity to the change in capacitance, the detection operation is started only when the indication means actually exists on the touch surface and also the touch surface is surely depressed; therefore, the device is not easily affected by the ambient noise and the condensation on the touch surface, thereby suppressing the occurrence of a malfunction thereof.

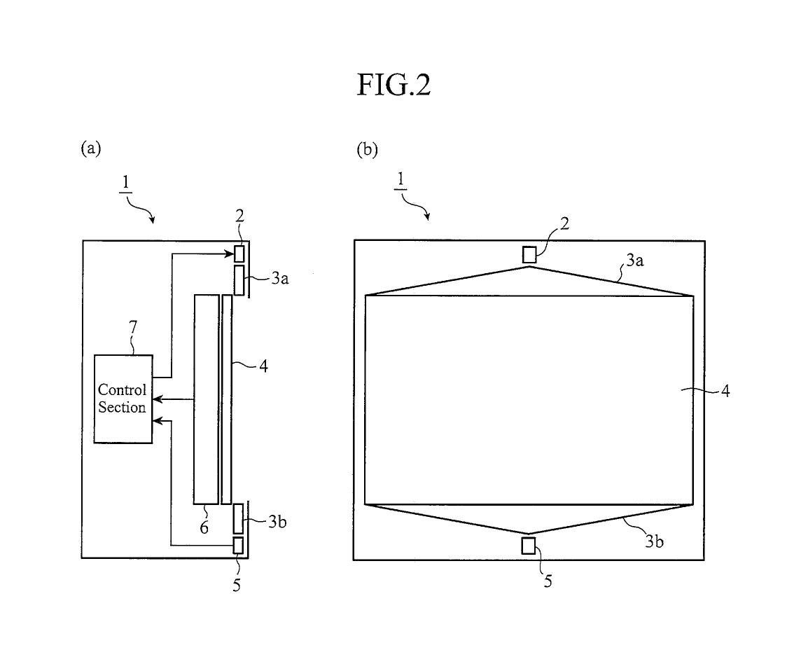

FIG. 2 is a view showing a configuration of a touch panel device in accordance with the first embodiment of the invention; FIG. 2(a) shows an internal configuration viewed from the side, and FIG. 2(b) shows the configuration viewed from the touch surface side. As shown in FIG. 2, the touch panel device 1 in accordance with the first embodiment includes an infrared light source 2; prisms 3a, 3b; a touch panel 4; a photosensor 5; a liquid crystal module 6; and a control section 7. As shown in FIG. 2(b), the infrared light source 2 and the prism 3a are provided in the position opposed to the prism 3b and the photosensor 5 across the touch surface of the touch panel 4. The infrared light for detection emitted by the infrared light source 2 is radiated with diffused parallel to the touch panel surface by the prism 3a, and the opposing prism 3b receives the infrared light for detection radiated through the prism 3a to condense the light into the photosensor 5. It is noted that an infrared LED and so on is specified as the infrared light source 2.

The photo sensor 5 is a sensor for receiving the infrared light for detection condensed by the prism 3b to output an electric signal according to the intensity of the infrared light for detection to the control section 7. The touch panel 4 is constructed to have a sensing electrode on the touch panel surface side and a driving electrode disposed opposite to the sensing electrode through a glass substrate; an electrostatic capacitance is created between the sensing electrode and the driving electrode, and a touch is detected by using the fact that the electrostatic capacitance is changed owing to the approach or contact of the indication means.

The liquid crystal module 6 is disposed on the internal side of the device (on the side opposite from the touch surface) with opposed to the touch panel 4, and constructed in a stacked manner of a liquid crystal layer, a pixel electrode, and a circuit board for driving the electrode. It is noted that a detection circuit for performing the touch detection operation of the touch panel 4 may be formed on the circuit board of the liquid crystal module 6. The control section 7 is a component for controlling the operation of the touch panel device 1, and controls an emission operation of the infrared light by the infrared light source 2, a determination operation for the presence or absence of the indication means based on the reception results of the infrared light by the photosensor 5, and a touch input operation by the electrostatic capacitance system of the touch panel 4.

Next, an operation thereof will be described.

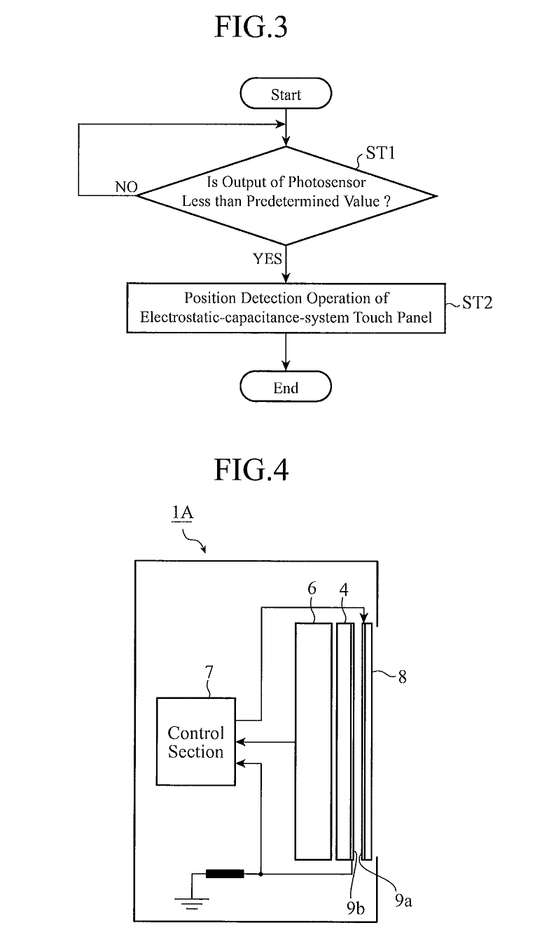

FIG. 3 is a flowchart showing the flow of an operation of the touch panel device in the first embodiment, and shows the operation at the stage prior to the detection of the touch input position by the electrostatic capacitance system.

First, the control section 7 controls the infrared light source 2 to emit continuously the infrared light at a certain intensity. The infrared light for detection emitted from the infrared light source 2 is diffused in parallel to the touch surface of the touch panel 4 through the prism 3a to be radiated. In such a way, the infrared light for detection serves as a probe for detecting the indication means on the touch surface. The infrared light for detection is received by the prism 3b disposed opposite to the prism 3a to be condensed into the photosensor 5. When receiving the infrared light for detection, the photosensor 5 outputs an electric signal according to the intensity of the infrared light for detection to the control section 7.

A predetermined electric signal value (a threshold value for the determination with the presence or absence of the interception) corresponding to the intensity of the infrared light for detection in the case received by the photosensor 5 without being intercepted on the touch surface is set previously in the control section 7. When the control section is placed in a touch-input waiting state in the aforementioned processing, it is determined whether the output value of the photo sensor 5 becomes less than the predetermined electric signal value or not (step ST1). At this stage, when the output value of the photo sensor 5 is equal to or more than the predetermined electric signal value (step ST1; NO), no indication means depressing the touch panel 4 is not present on the touch surface, and thereby the control section 7 returns to the processing at the step ST1, regardless of whether the electrostatic capacitance thereafter is changed on the touch panel 4 or not, and continues the touch-input waiting state.

On the other hand, when the output value of the photo sensor 5 becomes less than the predetermined electric signal value (step ST1; YES), the indication means depressing the touch panel 4 is present on the touch surface, and thereby when a change in the electrostatic capacitance thereafter is detected in the touch panel 4, the control section 7 carries out the detection of the touch position based on the detection results (step ST2). The detection operation of the touch position is similar to the content discussed with reference to FIG. 1.

As described above, in accordance with the first embodiment, the detection of the touch position by the electrostatic capacitance system is performed with an opportunity that the interception of the infrared light irradiated on the touch surface is detected; accordingly, even if the threshold value of the detection capacitance is lowered to increase the sensitivity with respect to the capacitance change, the detection of the touch position is not carried out as long as the infrared light irradiated on the touch surface is not intercepted by the indication means; therefore, the display device is not easily affected by ambient noise such as static electrical spark, water from the condensation on the touch face and so forth, and can restrain the occurrence of a malfunction thereof.

Further, in contrast to a conventional infrared touch sensor, infrared photosensors and photo sensors corresponding to the resolution of the touch input are not required, and the touch sensor can be adapted by at least one pair of the infrared light source 2 and the photosensor 5. It is noted that the configuration in accordance with the first embodiment has no effect on a multiple point input which is a feature of the touch panel 4 of the electrostatic capacitance system.

### Second Embodiment

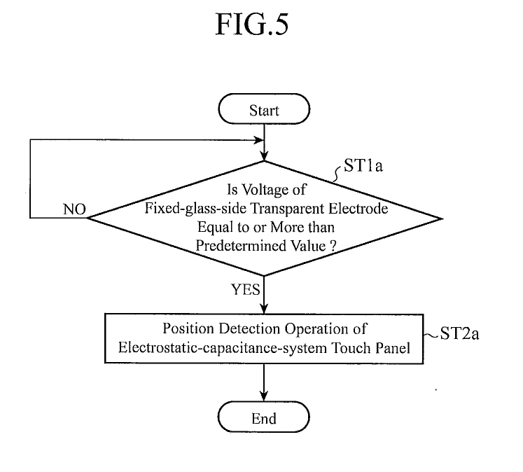

FIG. 4 is a view showing a configuration of a touch panel device in accordance with a second embodiment in the present invention. As shown in FIG. 4, a touch panel device 1A in accordance with the second embodiment includes a movable glass 8; a movable-glass-side transparent electrode 9a; a fixed-glass-side transparent electrode 9b; a touch panel 4; a liquid crystal module 6; and a control section 7. As in the first embodiment, the touch panel 4 is configured to have a sensing electrode on the touch surface side and a driving electrode disposed opposite to the sensing electrode through the glass substrate; an electrostatic capacitance is created between the sensing electrode and the driving electrode, and a touch is detected by using the change in the electrostatic capacitance owing to the approach or contact of an indication means. The touch panel 4 is fixedly disposed to the liquid crystal module 6 as the fixed glass. The liquid crystal module 6 is disposed on the internal side of the device (on the side opposite from the touch surface) with opposed to the touch panel 4, and constructed in a stacked manner of a liquid crystal layer, a pixel electrode, and a circuit board for driving the electrode.

Further, as shown in FIG. 4, the movable glass 8 is provided apart from the touch panel 4 by a predetermined space, and formed of a thin glass plate to be flexed by the depression of the indication means. The movable-glass-side transparent electrode 9a working as a resistive film is formed on the surface of the touch panel 4 side of the movable glass 8, while the fixed-glass-side transparent electrode 9b is provided with opposed to the movable-glass-side transparent electrode 9a on the surface of the movable glass 8 side of the touch panel 4.

A predetermined voltage is applied to the movable-glass-side transparent electrode 9a by the control section 7; the touch of the indication means is detected by using the change in the voltage of the fixed-glass-side transparent electrode 9b at the time the movable-glass-side transparent electrode 9a comes in contact with the fixed-glass-side transparent electrode 9b.

The control section 7 is a component for controlling the operation of the touch panel device 1A, and controls an application of a voltage to the movable-glass-side transparent electrode 9a, a determination operation for the presence or absence of the indication means based on the voltage change of the fixed-glass-side transparent electrode 9b, and a touch input operation by the electrostatic capacitance system of the touch panel 4.

Next, an operation thereof will be described.

FIG. 5 is a flowchart showing the flow of an operation of the touch panel device in accordance with the second embodiment, and shows the operation at the stage prior to the detection of the touch input position by the electrostatic capacitance system.

First, the control section 7 applies a predetermined voltage to the movable-glass-side transparent electrode 9a in advance, and makes a determination whether or not the voltage of the fixed-glass-side transparent electrode 9b becomes equal to or more than a predetermined value from the contact between the movable-glass-side transparent electrode 9a and the fixed-glass-side transparent electrode 9b by the depression of the movable glass 8 (step ST1a). At this stage, when the voltage of the fixed-glass-side transparent electrode 9b is less than the predetermined value (step ST1a; NO), it is determined that the touch surface is not depressed by the indication means, and thereby the control section 7 returns to the processing at the step ST1a, regardless of whether the electrostatic capacitance thereafter is changed on the touch panel 4 or not, and continues the touch-input waiting state.

On the other hand, when the voltage of the fixed-glass-side transparent electrode 9b becomes equal to or more than the predetermined value (step ST1a; YES), it is determined that the touch surface is depressed by the indication means, and thereby when a change in the electrostatic capacitance thereafter is sensed in the touch panel 4, the control section 7 performs the detection of the touch position based on the detection results (step ST2a). The detection operation of the touch position is similar to the content discussed with reference to FIG. 1 in the above first embodiment.

As described above, in accordance with the second embodiment, the depression of the movable glass 8 is detected from the change in the voltage of the fixed-glass-side transparent electrode 9b due to the contact between the movable-glass-side transparent electrode 9a and the fixed-glass-side transparent electrode 9b; with an opportunity of the detection, the detection of the touch position of the touch panel 4 is carried out by the electrostatic capacitance system. With such a configuration, even when the threshold value of the detection capacitance is lowered to increase the sensitivity to the capacitance change, the detection operation is started only when an indication means really depresses the touch surface for certain, and thereby the device is not easily affected by ambient noise such as static electrical spark, water from the condensation on the touch face and so on, thereby restraining the occurrence of a malfunction thereof.

Further, in contrast with a conventional touch panel of a resistive film system, it is not required that between a resistive film having electrodes formed in the X axis direction, and a resistive film having electrodes formed in the Y axis direction, the voltages of the respective electrodes be alternately detected; accordingly, the device can be configured simply by monitoring the voltage of the electrodes on one side (the fixed-glass-side transparent electrode 9b).

It is noted that the configuration in accordance with the second embodiment has no effect on a multiple point input which is a feature of the touch panel 4 of the electrostatic capacitance system.

Further, in the first embodiment or the second embodiment discussed above, it may be conceived that instead of performing the detection of the touch position by using the threshold value B of a high sensitivity as shown in FIG. 1 from the beginning, the control section 7 performs the detection of the touch position by the electrostatic capacitance system as follows: at first, the threshold value A of a low sensitivity, larger than the threshold value B, is set therein, and when the interception of the infrared light for detection or the contact of the resistive film is detected, the threshold value is gradually reduced from the threshold value A. By doing so, the detection of the touch position of a high sensitivity is not carried out more than necessary, and the resistance of the device to ambient noise can be enhanced.

Furthermore, in the first embodiment or second embodiment discussed above, it may be conceived that when the interception of the infrared light for detection or the contact of the resistive film is not detected, that is, when the indication means is not present on the touch surface, the upper limit value of a threshold value such that the control section 7 observes a change in detection capacitance caused by the effect of ambient noise and so on to determine the change in detection capacitance as a touch input, and a threshold value added by a predetermined minute amount to the upper limit value is used for the detection of the touch position where the interception of the infrared light for detection or the contact of the resistive film is detected. By also doing so, the detection of the touch position of a high sensitivity more than necessary is not carried out, so that the resistance of the device to ambient noise can be enhanced.

### INDUSTRIAL APPLICABILITY

Since the touch panel device according to the present invention is not easily affected to by ambient noise and so on, and can restrain the occurrence of a malfunction thereof, it is suitable for an input device and so on of a vehicle-mounted appliance placed in greatly changing ambient environment.

1. A touch panel device comprising:
a touch panel of an electrostatic capacitance system such that a touch input is detected according to whether a detection capacitance is beyond a predetermined threshold value or not;
a detection section that receives probe light irradiated on the touch surface of the touch panel to detect the presence or absence of the interception of the probe light from the intensity of the received light; and
a control section that performs the detection of a touch position of the touch panel by the electrostatic capacitance system such that the threshold value of the detection capacitance is set to a smaller value than the predetermined threshold value with an opportunity that the interception of the probe light is detected by the detection section.

2. A touch panel device comprising:
a touch panel of an electrostatic capacitance system such that a touch input is detected according to whether a detection capacitance is beyond a predetermined threshold value or not;
a detection section provided on the touch surface of the touch panel, having one pair of transparent substrates disposed apart from each other by a predetermined distance, and transparent electrodes formed on the opposing faces of the transparent substrates, respectively, wherein when a predetermined voltage is applied to one of the transparent electrodes, the depression of the transparent substrate is detected from a change in the voltage of the other transparent electrode due to a contact between the transparent electrodes; and
a control section that performs the detection of a touch position of the touch panel by the electrostatic capacitance system such that the threshold value of the detection capacitance is set to a smaller value than the predetermined threshold value with an opportunity that the depression of the transparent substrate is detected by the detection section.
